(19) United States
(12) Patent Application Publication
(10) Pub. No.: US 2023/0030626 A1
(43) Pub. Date: Feb. 2, 2023

(54) HYDROSILYLABLE MIXTURE INCLUDING STRONG ELECTRON DONORS, AS CATALYST ADDITIVE

(71) Applicants: WACKER CHEMIE AG, Munich (DE); TECHNISCHE UNIVERSITÄT MÜNCHEN, München (DE)

(72) Inventors: Richard WEIDNER, Burghausen (DE); Sebastian HÖLZL, Munich (DE); Felix KAISER, Erlangen (DE); Fritz KÜHN, Garching (DE)

(73) Assignee: Wacker Chemie AG, Munich (DE)

(21) Appl. No.: 17/784,116

(22) PCT Filed: Dec. 11, 2019
(86) PCT No.: PCT/EP2019/084652

§ 371 Date: Jun. 10, 2022

(51) Int. Cl. C07F 7/30; C07F 7/08; B01J 31/12

(52) U.S. Cl. CPC C07F 7/30; C07F 7/0829; B01J 31/123

(57) ABSTRACT

A hydrolysable mixture M contains a) at least one compound A with at least one hydrogen atom directly bonded to a silicon atom, b) at least one compound B that contains at least one carbon-carbon multiple bond, c) at least one hydrosilylation catalyst, and d) at least one strong electron donor, as a catalyst additive.

The present invention discloses a hydrosilylable mixture M that in addition to the hydrosilylation catalyst comprises at least one strong electron donor. Additionally disclosed are N-heterocyclic germylenes as strong electron donors, and also a method for preparing siloxanes in the presence of at least one hydrosilylation catalyst and in the presence of at least one strong electron donor as catalyst additive, preferably at least one N-heterocyclic germylene.

The hydrosilylation of olefins is an important reaction worldwide for the production of silicon-containing raw products such as siloxanes and silicones, which are widely used in the form of polymeric materials, crosslinkers or industrial adhesives. This involves the use every year of several tons of platinum in catalysts, which in the course of production remains in the product and is thus removed from the value chain. The Karstedt catalyst that is mostly used for this purpose generally exhibits very high activity, the selectivity of the reaction and thus the yield of the target product being in the range of 50-80%, depending on the conditions. For this reason, improving the selectivity of the reaction offers enormous potential for savings on resources and financial savings. By improving the selectivity, fewer by-products that would have to be laboriously removed from the product are formed during production.

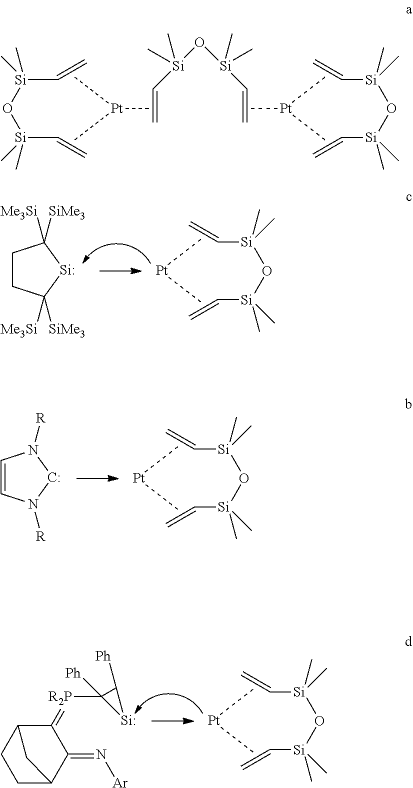

FIG. 1: Platinum complexes used in olefin hydrosilylation. (a) Karstedt 1973, (b) Markó 2002, (c) Iwamoto 2016, (d) Kato, Baceiredo 2016.

A number of modifications to Karstedt's catalyst have been published in recent years. Important examples thereof are shown in FIG. 1. The reaction of Karstedt's catalyst with N-heterocyclic carbenes (NHCs) results in the formation of (NHC)Pt(dvtms) complexes.

The coordination of a strong electron donor at the platinum center leads overall to a slowing of the catalytic reaction as a consequence of a significantly longer initiation phase. At the same time, an improvement in selectivity is achieved. In addition, heavy homologs of NHCs, in particular donor-stabilized silylenes, have been tested as ligands on Karstedt's catalyst in the hydrosilylation of olefins (Organometallics 2016, 35, 4071-4076; Inorg. Chem. 2016, 55, 8234-8240; Dalton Trans. 2017, 46, 8868-8864). These silylenes allow very good yields accompanied by good functional group tolerance to be achieved.

However, a disadvantage of this procedure is that, in order to be subsequently used as a catalyst, the employed complexes first have to be laboriously prepared by reacting Karstedt's catalyst with the respective ligand and then purified. The catalytically active species is formed in situ only after a ligand has dissociated. The preparative effort involved accordingly makes these complexes unattractive for industrial uses.

The germylene [1,2-(tBuCH₂N)₂C₆H₄]Ge (hereinafter referred to as NeoGe) is already known from J. Chem. Soc., Dalton Trans. 2000, 3094-3099, but not in connection with Pt(0)-catalyzed hydrosilylation.

The invention provides N-heterocyclic germylenes of general formula (I),

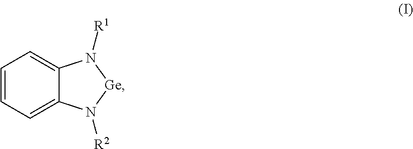

wherein the following applies for the radicals R¹ and R²:

(a) the radicals R¹ and R² are independently selected from substituted or unsubstituted alkyl-attached alkylheteroaryl radicals having a total of 1-30 carbon atoms and at least one heteroatom selected from nitrogen, sulfur, and oxygen; or

(b) the radical R¹ is a substituted or unsubstituted alkyl-attached alkylheteroaryl radical having a total of 1-30 carbon atoms and at least one heteroatom selected from nitrogen, sulfur and oxygen, and the radical R² is selected from (i) unsubstituted aliphatic C₁-C₂₀ hydrocarbon radical, and (ii) substituted or unsubstituted alkyl-attached alkylaryl radical having a total of 1-30 carbon atoms;

where substituted in each case means that at least one hydrogen atom of the alkylaryl or alkylheteroaryl radical has been replaced by a C₁-C₁₀ hydrocarbon radical.

In formula (I), the following preferably applies for the radicals R¹ and R²:

(a) the radicals R¹ and R² are independently selected from substituted or unsubstituted alkyl-attached alkylheteroaryl radicals having a total of 1-30 carbon atoms and at least one nitrogen atom; or

(b) the radical R¹ is a substituted or unsubstituted alkyl-attached alkylheteroaryl radical having a total of 1-30 carbon atoms and at least one nitrogen atom, and the radical R² is selected from unsubstituted aliphatic C₁-C₂₀ hydrocarbon radicals; where substituted in each case means that at least one hydrogen atom of the alkylheteroaryl radical has been replaced by a C₁-C₁₀ hydrocarbon radical.

In formula (I), the following particularly preferably applies for the radicals R¹ and R²: a) the radicals R¹ and R² are identical and an unsubstituted or substituted pyridin-2-ylmethyl radical, where substituted means that at least one hydrogen atom of the pyridine ring has been replaced by a C₁-C₁₀ hydrocarbon radical; or

(b) the radical R¹ is an unsubstituted or substituted pyridin-2-ylmethyl radical, where substituted means that at least one hydrogen atom of the pyridine ring has been replaced by a C₁-C₁₀ hydrocarbon radical, and the radical R² is a neopentyl radical.

In formula (I), the following very particularly preferably applies for the radicals R¹ and R²:

i) the radicals R¹ and R² are identical and an unsubstituted pyridin-2-ylmethyl radical; or

(ii) the radical R¹ is an unsubstituted pyridin-2-ylmethyl radical, and the radical R² is a neopentyl radical.

Very particularly preferred compounds of formula (I) are the following germylenes

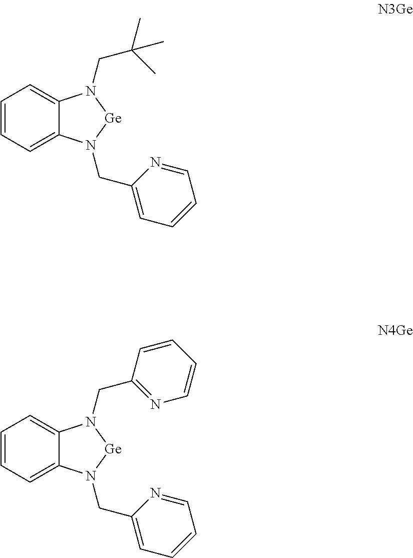

The invention further provides a hydrosilylable mixture M comprising

a) at least one compound A having at least one hydrogen atom attached directly to a silicon atom;

b) at least one compound B that contains at least one carbon-carbon multiple bond;

c) at least one hydrosilylation catalyst, and

d) at least one strong electron donor as a catalyst additive.

For the purposes of the present invention, strong electron donors are understood as meaning good sigma donors. Phosphines, amines, carbon monoxide, and low-valent compounds of the 14th main group, such as carbenes, silylenes and germylenes, are known as strong electron donors in the specialist literature. The donor strength can often be determined experimentally through spectroscopic analysis of corresponding transition metal complexes (e.g. changes in CO vibrations by IR spectroscopy). In the case of compounds that are unstable to air and to hydrolysis, for example tetrylenes, the bond geometry and energy are analyzed primarily by means of quantum chemical calculations.

The strong electron donor is preferably selected from the group consisting of phosphines, carbenes, silylenes, and germylenes.

The strong electron donor is particularly preferably selected from N-heterocyclic germylenes of general formula (I′)

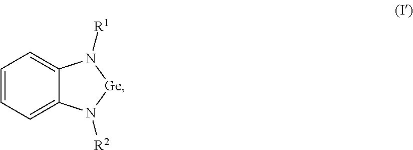

where the radicals R¹ and R² are independently a substituted or unsubstituted hydrocarbon radical having 1-30 carbon atoms, where substituted means that at least one carbon atom has been replaced by a heteroatom selected from nitrogen, sulfur, and oxygen.

The strong electron donor is very particularly preferably selected from the N-heterocyclic germylenes of general formula (I) of the invention and the preferred radicals R¹ and R² described therein. Most preferably, the strong electron donor is selected from the previously described compounds N3Ge and N4Ge.

The compound A is preferably at least one compound selected from

(a1) Compounds of General Formula (II)

R¹R²R³Si—H (II)

wherein the radicals R¹, R², and R³ are independently selected from the group consisting of (i) hydrogen, (ii) halogen, (iii) unsubstituted or substituted C₁-C₂₀ hydrocarbon radical, and (iv) unsubstituted or substituted C₁-C₂₀ hydrocarbonoxy radical, where two of the radicals R¹, R², and R³ may also together form a monocyclic or polycyclic, unsubstituted or substituted C₂-C₂₀ hydrocarbon radical, where substituted in each case means that the hydrocarbon radical or hydrocarbonoxy radical independently has at least one of the following substitutions: a hydrogen atom may be replaced by halogen, —C≡N, —OR^{z}, —SR^{z}, —NR^{z}₂, —PR^{z}₂, —O—CO—R^{z}, —NH—CO—R^{z}, —O—CO—OR^{z} or —COOR^{z}, a CH₂ group may be replaced by —O—, —S— or —NR^{z}—, and a carbon atom may be replaced by a silicon atom, wherein R^{z} is in each case independently selected from the group consisting of hydrogen, C₁-C₆ alkyl radical, C₆-C₁₄ aryl radical, and C₂-C₆ alkenyl radical; and/or

(a2) Compounds of General Formula (II′)

(SiO_{4/2})ₐ(R^{x}SiO_{3/2})_{b′}(R^{x}₂SiO_{2/2})_{c}(R^{x}HSiO_{2/2})_{c′}(H₂SiO_{2/2})_{c″}(R^{x}₃SiO_{1/2})_{d}(HR^{x}₂Si O_{1/2})_{d′}(H₂R^{x}SiO_{1/2})_{d″}(H₃SiO_{1/2})_{d′″} (II′),

wherein the radicals R^{x} are independently selected from the group consisting of (i) halogen, (ii) unsubstituted or substituted C₁-C₂₀ hydrocarbon radical, and (iii) unsubstituted or substituted C₁-C₂₀ hydrocarbonoxy radical, where substituted in each case means that the hydrocarbon radical or hydrocarbonoxy radical independently has at least one of the following substitutions: A hydrogen atom may be replaced by halogen, a CH₂ group may be replaced by —O— or —NR^{z}—, where R^{z} is in each case independently selected from the group consisting of hydrogen, C₁-C₆ alkyl radical, C₆-C₁₄ aryl radical, and C₂-C₆ alkenyl radical;

and wherein the indices a, b, b′, c, c′, c″, d, d′, d″, d′″ indicate the number of respective siloxane units in the compound and independently represent an integer within a range from 0 to 100 000, with the proviso that the sum of a, b, b′, c, c′, c″, d, d′, d″, d′″ together has a value of at least 2 and that at least one of the indices b′, c′, c″, d′, d″ or d′″ is not equal to 0.

The mixture M preferably comprises at least one compound A, this also encompassing mixtures of compounds of general formula (II) and/or mixtures of compounds of general formula (II′).

In formula (II) the radicals R¹, R², and R³ are preferably independently selected from the group consisting of (i) hydrogen, (ii) chlorine, (iii) unsubstituted or substituted C₁-C₁₂ hydrocarbon radical, and (iv) unsubstituted or substituted C₁-C₁₂ hydrocarbonoxy radical, where “substituted” has the meaning defined above; and in formula (II′) the radicals R^{x} are preferably independently selected from the group consisting of chlorine, C₁-C₆ alkyl radical, C₂-C₆ alkenyl, phenyl, and C₁-C₆ alkoxy radical, and the indices a, b, b′, c, c′, c″, d, d′, d″, d′″ are independently selected from an integer within a range from 0 to 1000.

In formula (II) the radicals R¹, R², and R³ are particularly preferably selected from the group consisting of (i) hydrogen, (ii) chlorine, (iii) C₁-C₆ alkyl radical, (iv) C₂-C₆ alkenyl, (v) phenyl, and (vi) C₁-C₆ alkoxy radical; and in formula (II′) the radicals R^{x} are particularly preferably independently selected from the group consisting of chlorine, methyl, methoxy, ethyl, ethoxy, n-propyl, n-propoxy, and phenyl, and the indices a, b, b′, c, c′, c″, d, d′, d″, d′″ are independently selected from an integer within a range from 0 to 1000.

In formula (II) the radicals R¹, R², and R³ and in formula (II′) the radical R^{x} are very particularly preferably independently selected from the group consisting of hydrogen, chlorine, methyl, methoxy, ethyl, ethoxy, n-propyl, n-propoxy, and phenyl, and the indices a, b, b′, c, c′, c″, d, d′, d″, d′″ are preferably independently selected from an integer within a range from 0 to 1000.

A mixture of compounds of formula (II′) is present especially in the case of polysiloxanes. However, for the sake of simplicity it is not the individual compounds that are specified for polysiloxanes but rather a formula (II′) similar to average formula (II′a)

(SiO_{4/2})ₐ(R^{x}SiO_{3/2})_{b′}(R^{x}₂SiO_{2/2})_{c}(R^{x}HSiO_{2/2})_{c′}(H₂SiO_{2/2})_{c″}(R^{x}₃SiO_{1/2})_{d}(HR^{x}₂Si O_{1/2})_{d′}(H₂R^{x}SiO_{1/2})_{d″}(H₃SiO_{1/2})_{d′″} (II′a),

wherein the radicals R^{x} are as defined in formula (II′), but the indices a, b, b′, c, c′, c″, d, d′, d″, d″′ independently represent a number within a range from 0 to 100 000 and indicate the average content of the respective siloxane unit in the mixture. Preference is given to using mixtures of formula (II′a) wherein the indices a, b, b′, c, c′, c″, d, d′, d″, d″′ are independently selected from a number within a range from 0 to 20 000.

Examples of compounds A of general formula (II) are the following silanes (Ph=phenyl, Me=methyl, Et=ethyl): Me₃SiH, Et₃SiH, Me₂PhSiH, MePh₂SiH, Me₂ClSiH, Et₂ClSiH, MeCl₂SiH, Cl₃SiH, Me₂(MeO)SiH, Me(MeO)₂SiH, (MeO)₃SiH, Me₂(EtO)SiH, Me(EtO)₂SiH, (EtO)₃SiH; and examples of compounds A of general formula (II′) are the following siloxanes and polysiloxanes:

HSiMe₂-O—SiMe₂H, Me₃Si—O—SiHMe₂, Me₃Si—O—SiHMe-O—SiMe₃,

H—SiMe₂-(O—SiMe₂)ₘ—O—SiMe₂-H, wherein m is a number within a range from 1 to 20 000,

Me₃Si—O—(SiMe₂-O)ₙ(SiHMe-O)ₒ—SiMe₃, wherein n and o are independently a number within a range from 1 to 20 000,

H—SiMe₂-(O—SiMe₂)ₚ—(SiHMe-O)_{q}O—SiMe₂-H, wherein p is a number in the range 0 to 20 000 and q is a number within a range from 1 to 20 000.

The compound B is preferably at least one compound selected from (b1) compounds of general formula (III)

R⁴R⁵C═CR⁶R⁷ (III), and/or

(b2) compounds of general formula (III′)

R⁸C≡CR⁹ (III′),

wherein the radicals R⁴, R⁵, R⁶, RT, R⁸, and R⁹ are independently selected from the group consisting of (i) hydrogen, (ii) —C≡N, (iii) organosilicon radical having 1-100 000 silicon atoms, (iv) unsubstituted or substituted C₁-C₂₀ hydrocarbon radical, and (v) unsubstituted or substituted C₁-C₂₀ hydrocarbonoxy radical, where two of the radicals R⁴, R⁵, R⁶, and RT may also together form a monocyclic or polycyclic, unsubstituted or substituted C₂-C₂₀ hydrocarbon radical, where substituted in each case means that the hydrocarbon radical or hydrocarbonoxy radical independently has at least one of the following substitutions: a hydrogen atom may be replaced by halogen, —C≡N, —OR^{z}, —SR^{z}, —NR^{z}₂, —PR^{z}₂, —O—CO—R^{z}, —NH—CO—R^{z}, —O—CO—OR^{z}, —COOR^{z} or —[O—(CH₂)ₙ]ₒ—(CH(O)CH₂), where n=1-6 and o=1-100, a CH₂ group may be replaced by —O—, —S— or —NR^{z}—, and a carbon atom may be replaced by a silicon atom, wherein R^{z} is in each case independently selected from the group consisting of hydrogen, C₁-C₆ alkyl, C₆-C₁₄ aryl, and C₂-C₆ alkenyl; and/or

(b3) compounds of general formula (III″)

R^{x}₃Si—O[—SiR^{x}₂—O]ₘ—[Si(MB)R^{x}—O]ₙ—SiR^{x}₃ (III″),

wherein the radicals R^{x} are independently selected from the group consisting of (i) hydrogen, (ii) halogen, (iii) MB, (iv) unsubstituted or substituted C₁-C₂₀ hydrocarbon radical, and (v) unsubstituted or substituted C₁-C₂₀ hydrocarbonoxy radical; and wherein MB each independently represent (i) —(CH₂)ₒ—CR═CR₂ or (ii) —(CH₂)ₒ—C≡CR, where o=0-12 and wherein R is in each case independently selected from the group consisting of (i) hydrogen, (ii) halogen, (iii) unsubstituted or substituted C₁-C₂₀ hydrocarbon radical, and (iv) unsubstituted or substituted C₁-C₂₀ hydrocarbonoxy radical, where substituted in each case means that the hydrocarbon radical or hydrocarbonoxy radical independently has at least one of the following substitutions: a hydrogen atom may be replaced by halogen, —C≡N, —OR^{z}, —SR^{z}, —NR^{z}₂, —PR^{z}₂, —O—CO—R^{z}, —NH—CO—R^{z}, —O—CO—OR^{z} or —COOR^{z}, a CH₂ group may be replaced by —O—, —S— or —NR^{z}—, and a carbon atom can be replaced by a silicon atom, wherein R^{z} is in each case independently selected from the group consisting of hydrogen, C₁-C₆ alkyl radical, C₆-C₁₄ aryl radical, and C₂-C₆ alkenyl radical, and wherein m and n independently represent an integer within a range from 0 to 100 000, with the proviso that the compound contains at least one radical MB.

The mixture M comprises at least one compound B, this also encompassing mixtures of compounds of general formula (III) and/or mixtures of compounds of general formula (III′) and/or mixtures of compounds of general formula (III″).

Organosilicon radical in formula (III′) means a compound having at least one direct Si—C bond in the molecule.

In the formulas (III) and (III′), the radicals R⁴, R⁵, R⁶, R⁷, R⁸, and R⁹ are preferably independently selected from the group consisting of (i) hydrogen, (ii) —C≡N, (iii) unsubstituted or substituted C₁-C₁₂ hydrocarbon radical, (iv) unsubstituted or substituted C₁-C₁₂ hydrocarbonoxy radical, where substituted in each case means that the hydrocarbon radical or hydrocarbonoxy radical independently has at least one of the following substitutions: a hydrogen atom may be replaced by halogen, —C≡N, C₁-C₆ alkoxy, —NR^{z}₂, —O—CO—R^{z}, —NH—CO—R^{z}, —O—CO—OR^{z}, —COOR^{z} or —[O—(CH₂)ₙ]ₒ—(CH(O)CH₂), where n=1-3 and o=1-20, wherein R^{z} is in each case independently selected from the group consisting of hydrogen, chlorine, C₁-C₆ alkyl, C₂-C₆ alkenyl, and phenyl; and (v) organosilicon radical selected from the general formula (IIIa),

—(CH₂)ₙ—SiR^{x}₃ (IIIa),

wherein the radicals R^{x} are independently selected from the group consisting of (i) hydrogen, (ii) halogen, (iii) unsubstituted or substituted C₁-C₂₀ hydrocarbon radical, and (iv) unsubstituted or substituted C₁-C₂₀ hydrocarbonoxy radical, where substituted in each case means that the hydrocarbon radical or hydrocarbonoxy radical independently has at least one of the following substitutions: A hydrogen atom may be replaced by halogen, a CH₂ group may be replaced by —O— or —NR^{z}—, where R^{z} is selected from the group consisting of hydrogen, C₁-C₆ alkyl, C₆-C₁₄ aryl, and C₂-C₆ alkenyl;

and wherein n=0-12;

and, in formula (III″), the radicals R^{x} are preferably independently selected from the group consisting of (i) hydrogen, (ii) chlorine, (iii) C₁-C₆ alkyl radical, (iv) phenyl, (v) MB, and (vi) C₁-C₆ alkoxy radical, where MB is in each case independently (i) —(CH₂)ₒ—CR═CR₂ or (ii) —(CH₂)O—C≡CR, where O=0-6, and wherein R is in each case independently selected from the group consisting of (i) hydrogen, (ii) chlorine, (iii) C₁-C₆ alkyl radical, (iv) phenyl, and (v) C₁-C₆ alkoxy radical.

In the formulas (III) and (III′) the radicals R⁴, R⁵, R⁶, RT, R⁸, and R⁹ are particularly preferably independently selected from the group consisting of (i) hydrogen, (ii) —C≡N, (iii) organosilicon radical selected from general formula (IIIa), wherein the radicals R^{x} are independently selected from the group consisting of hydrogen, chlorine, C₁-C₆ alkyl radical, C₂-C₆ alkenyl radical, phenyl, and C₁-C₆ alkoxy radical, (iv) unsubstituted or substituted C₁-C₆ hydrocarbon radical, and (v) unsubstituted or substituted C₁-C₆ hydrocarbonoxy radical, where substituted in each case means that the hydrocarbon radical or hydrocarbonoxy radical independently has at least one of the following substitutions: a hydrogen atom may be replaced by chlorine, —C≡N, —O—CH₂—(CH(O)CH₂) (=glycidoxy radical), —NR^{z}₂, and —O—CO—R^{z}, where R^{z} is in each case independently selected from the group consisting of hydrogen and C₁-C₆ alkyl; and in formula (III″) the radicals R^{x} are particularly preferably independently selected from the group consisting of C₁-C₃ alkyl radical and MB, where MB in each case represents —(CH₂)ₒ—CR═CR₂, where R is in each case hydrogen and O=0-6.

Examples of compounds of formula (III″) are

R^{x}₃Si—O[—SiR^{x}₂—O]ₘ—[Si(MB)₂—O]₁₋₁₀₀₀₀₀—SiR^{x}₃,

R^{x}₃Si—O[—SiR^{x}₂—O]ₘ—[Si(MB)R^{x}—O]₁₋₁₀₀₀₀₀—SiR^{x}₃,

(MB)R^{x}₂Si—O[—SiR^{x}₂—O]ₘ—[Si(MB)R^{x}—O]ₙ—SiR^{x}₃,

(MB)R^{x}₂Si—O[—SiR^{x}₂—O]ₘ—[Si(MB)₂—O]ₙ—SiR^{x}₃,

(MB)R^{x}₂Si—O[—SiR^{x}₂—O]ₘ—[Si(MB)R^{x}—O]ₙ—SiR^{x}₂(MB),

(MB)R^{x}₂Si—O[—SiR^{x}₂—O]ₘ—[Si(MB)₂—O]ₙ—SiR^{x}₂(MB),

wherein MB in each case independently represents (i) —(CH₂)ₒ—CR═CR₂ or (ii) —(CH₂)ₒ—C≡CR, where O=0-12 and wherein R^{x}, m, and n are as defined in formula (III″).

Examples of compounds B are ethylene, propylene, 1-butylene, 2-butylene, isoprene, 1,5-hexadiene, cyclohexene, dodecene, cycloheptene, norbornene, norbornadiene, indene, cyclooctadiene, styrene, α-methylstyrene, 1,1-diphenylethylene, cis-stilbene, trans-stilbene, 1,4-divinylbenzene, allylbenzene,

allyl chloride, allylamine, dimethylallylamine, acrylonitrile, allyl glycidyl ether, vinyl acetate,

vinyl-Si(CH₃)₂OMe, vinyl-SiCH₃(OMe)₂, vinyl-Si(OMe)₃,

vinyl-Si(CH₃)₂—O—[Si(CH₃)₂—O]ₙ—Si(CH₃)₂-vinyl, where n=0 to 10 000, vinyl-Si(CH₃)₂—O—[Si(CH₃)₂—O]ₙ—[Si(vinyl)Me-O]ₒSi(CH₃)₂-vinyl, where n=0 to 20 000 and o=1 to 20 000,

Me₃Si—O—(SiMe₂-O)ₙ—[Si(vinyl)Me-O]ₒ—SiMe₃, where n=1 to 20 000 and o=1 to 20 000,

acetylene, propyne, 1-butyne, 2-butyne, and phenylacetylene.

In a particular embodiment, the compound A and the compound B are present in one molecule. Examples of such molecules are vinyldimethylsilane, allyldimethylsilane, vinylmethylchlorosilane and vinyldichlorosilane.

The hydrosilylation catalyst employed may be any catalyst known for hydrosilylation to those skilled in the art. Preference is given to noble metal catalysts such as catalysts of platinum, palladium, iridium or rhodium. Particular preference is given to using Pt(0) species as the catalyst. The Pt(0) species employed may be any Pt(0) catalyst known for hydrosilylation to those skilled in the art, preference being given to Karstedt's catalyst. The amount of Pt(0) species may be freely chosen by those skilled in the art; typically, the Pt(0) species is used in a content from 1 ppm to 500 ppm [Pt].

The molar ratio of hydrosilylation catalyst to electron donor may be freely chosen by those skilled in the art.

If the catalyst used is a Pt(0) species and the electron donor an N-heterocyclic germylene of formula (I′), the molar ratio of Pt(0) species to N-heterocyclic germylene is usually within a range from 1:0.1 to 1:10. The molar ratio of Pt(0) species to N-heterocyclic germylene is preferably within a range from 1:1 to 1:5, more preferably within a range from 1:1 to 1:2.

The invention further provides a method for preparing siloxanes, comprising the following steps:

a) preparing a hydrosilylable mixture M of the invention by contacting the individual components with one another, and

b) reacting the hydrosilylable mixture M at a temperature within a range from 25° C. to 200° C.

The reaction is preferably carried out at a temperature within the range 80-150° C. The reaction is particularly preferably carried out at a temperature within the range 100-150° C.

The invention further provides for the use of phosphines, carbenes, silylenes, and germylenes as catalyst additives in noble metal-catalyzed hydrosilylation, especially in platinum(0)-catalyzed hydrosilylation. Preference is given to a use wherein the germylene is an N-heterocyclic germylene of general formula (I′)

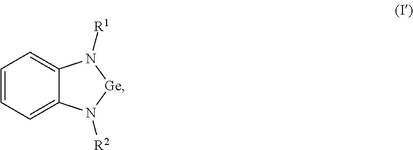

where the radicals R¹ and R² are independently a substituted or unsubstituted hydrocarbon radical having 1-30 carbon atoms, where substituted means that at least one carbon atom has been replaced by a heteroatom selected from nitrogen, sulfur, and oxygen.

### EXAMPLES

The method of the invention is what is known as an additive catalysis. This means that strong electron donors are added to the hydrosilylation catalyst (e.g. Pt(0) species such as Karstedt's catalyst) in the reaction mixture solely as additives, thereby influencing the reaction characteristics such as rate, selectivity or yield. It is not necessary to synthesize and isolate a catalyst-donor complex in order to use it as the catalytically active species.

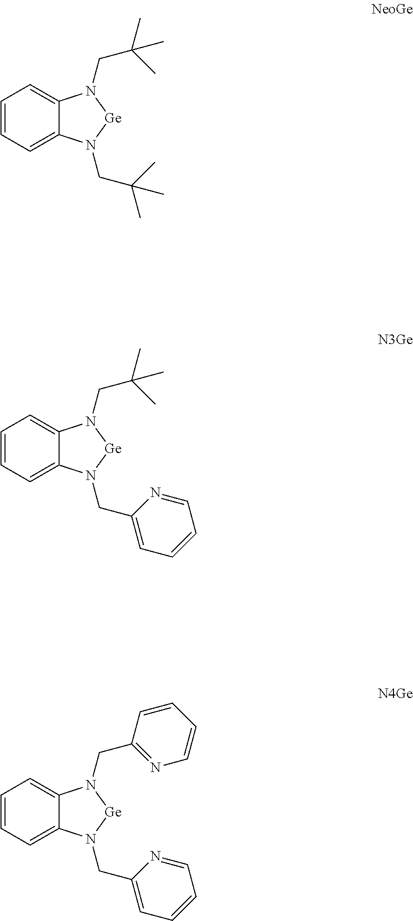

FIG. 2: N-Heterocyclic germylenes used as an additive.

The Pt(0) species most commonly used for hydrosilylation is Karstedt's catalyst. When using Karstedt's catalyst, a significant adverse effect on product yield arises through the formation and agglomeration of colloidal platinum during the catalytic reaction. The formation of the latter can be suppressed by using coordinating ligands. The compounds shown in FIG. 1 above benefit from this effect. It should also be mentioned that the use of additionally coordinating elements in the ligand system (multiply coordinating, chelating ligands) can additionally enhance the stability of a coordination compound. On the other hand, it should be noted that overloading the catalytic system with electron-donating compounds can lead to a significant slowing of the reaction or almost complete loss of catalytic activity.

As well as carbenes and silylenes, various N-heterocyclic germylenes have been tested as additives in hydrosilylation together with Karstedt's catalyst.

In all the compounds investigated, the catalytically active species must first be formed from the coordinatively stabilized platinum complexes. If a ligand coordinates strongly/if the coordination compound is strongly stabilized, substantial initiation phases can occur. The use of N-heterocyclic germylenes having variable side branches permits high electronic flexibility at the metal center and thus rapid and selective catalysis. As shown below, very high selectivities can be achieved in the catalytic hydrosilylation with Karstedt's catalyst when using strong electron donors and in particular NHGe as an additive, even at elevated temperatures. This represents a significant improvement, since a high yield is achieved in a relatively short time.

### 1. Preparation of N-Heterocyclic Dermylenes (NHGe)

### A) N3Ge

### 2,2-Dichloro-N,N′-neopentyl(pyridin-2-ylmethyl)benzimidazoline-2-germanium

N,N′-Neopentyl(pyridin-2-ylmethyl)-1,2-diaminobenzene (912 mg, 3.39 mmol, 1.0 equiv.), and DABCO (399 mg, 3.55 mmol, 1.1 equiv.) are dissolved in 15 mL of dry and degassed THF under an inert atmosphere. GeCl₄ (402 μl, 755 mg, 3.52 mmol, 1.1 equiv.) is added, whereupon a light yellow suspension immediately forms. The reaction is stirred at room temperature for 20 hours, filtered through a filter pad, and reduced to approx. 6 mL. 12 mL of dry and degassed pentane is added and the solution is stored at −30° C. After 1 day, a large quantity of green crystals suitable for single-crystal X-ray diffractometry has formed. The crystals are filtered off, washed with dry and degassed pentane (2×5 mL) and dried under reduced pressure. The product is isolated as a green crystalline solid. Yield: 81% (1.12 g, 2.73 mmol).

¹H NMR (C₆D₆): δ=8.63 (dt, ³J=5.6, ⁴J=1.4, 1H, CH-1), 7.14-7.03 (m, 2H, CH-12; 13), 6.96 (td, ³J=7.6, ⁴J=1.4, 1H, CH-11), 6.65 (td, ³J=7.6, ⁴J=1.4, 1H, CH-3), 6.54 (dd, ³J=7.6, ⁴J=1.3, 1H, CH-10), 6.38 (ddd, ³J=7.3, 5.6, ⁴J=1.2, 1H, CH-2), 6.02 (dt, ³J=7.6, 1H, CH-4), 3.89 (br, 2H, CH-17), 3.75 (s, 2H, CH-7), 1.34 (s, 9H, CH-19; 20; 21).

¹³C NMR (C₆D₆): δ=150.7 (C-5), 143.5 (C-1), 141.2 (C-9), 139.1 (C-3), 133.6 (C-14), 123.7 (C-2), 122.0 (C-4), 119.2 (C-12), 116.1 (C-11), 109.3 (C-13), 108.6 (C-10), 57.4 (C-17), 44.3 (C-7), 34.3 (C-18), 30.2 (C-19-21).

HRMS (LIFDI, toluene): m/z=411.0242[32]⁺ (calculated C₁₇H₂₁N₃GeCl₂: 411.04320).

Elemental analysis: calculated for N3GeCl₂ (%): C, 49.69, H, 5.15, N, 10.23; found=C, 49.95, H, 5.25, N, 9.92.

### N,N′-Neopentyl(pyridin-2-ylmethyl)benzimidazoline-2-germylene (N3Ge)

10 mL of dry and degassed THF is added to a mixture of 2,2-dichloro-N,N′-neopentyl(pyridin-2-ylmethyl)benzimidazoline-2-germanium (224 mg, 545 μmol, 1.0 equiv.) and KC₈ (147 mg, 1.09 mmol, 2.0 equiv.) at −78° C. under an inert atmosphere. The suspension turns yellow on warming to room temperature and is stirred for a further 20 hours. The resulting suspension is filtered, evaporated to dryness, dissolved in 2 mL of dry and degassed diethyl ether, and filtered again. The solution is stored at −32° C. for 24 hours, whereupon a large quantity of solid, crystal-containing crystals suitable for single-crystal X-ray diffractometry is formed. The crystals are filtered off, washed with dry and degassed pentane (2×5 mL) and dried under reduced pressure. The product is isolated as a yellow crystalline solid. Yield: 69% (128 mg, 376 μmol)

¹H NMR (C₆D₆): δ=8.47 (ddd, ³J=4.9, ⁴J=1.8, ⁵J=0.9, 1 H, CH-1), 7.10-6.99 (m, 3H, CH-10; 11; 12), 6.96-6.90 (m, 1H, CH-13), 6.87 (td, ³J=7.7, ⁴J=1.8, 1H, CH-3), 6.76 (d, ³J=7.7, 1H, CH-4), 6.54 (ddd, ³J=7.7, 4.9, ⁴J=1.3, 1H, CH-2), 5.29 (s, 2H, CH-7), 3.74 (s, 2H, CH-17), 0.87 (s, 9H, CH-19; 20; 21).

¹³C NMR (C₆D₆): δ=160.2 (C-5), 149.5 (C-1), 144.1 (C-14), 142.1 (C-9), 136.3 (C-3), 121.9 (C-2), 121.1 (C-4), 118.6 (C-10/13), 118.2 (C-10/13), 110.6 (C-11/12), 110.5 (C-11/12), 56.8 (C-17), 52.0 (C-7), 33.0 (C-18), 28.6 (C-19; 20; 21).

HRMS (LIFDI, toluene): m/z=341.0976[33]⁺ (calculated for C₁₇H₂₁N₃Ge: 341.0950).

Elemental analysis: Calculated for N3Ge (%): C, 60.05, H, 6.23, N, 12.36; found: C, 59.77, H, 6.30, N, 12.28.

### b) N4Ge

702 mg of N,N′-di(pyridin-2-ylmethyl)-1,2-diaminobenzene (2.42 mmol, 1.0 equiv.) is dissolved in 10 mL of THF (dry, degassed) and a solution of Ge[N(SiMe₃)₂]₂ (952 mg, 2.42 mmol, 10 equiv.) in 2 mL of THF (dry, degassed) slowly added under an inert atmosphere. The reaction mixture is heated to reflux for 3 days, after which the solvent is removed under reduced pressure (10⁻⁸ bar). The crude product can be purified by distillation under high vacuum at 250° C. Crystals can be grown from a THF solution at −32° C. Yield: 80% (697 mg, 1.94 mmol).

¹H NMR (THF-d₈): δ=8.53 (dd, ³J=4.8, ⁴J=1.7, 2H), 7.52 (td, ³J=7.7, ⁴J=1.8, 2H), 7.21-7.11 (m, 4H), 6.87 (m, 2H), 6.73-6.67 (m, 2H), 5.35 (s, 4H).

¹³C NMR (THF-d₈): δ=161.2, 150.3, 143.8, 137.6, 123.1, 122.3, 119.1, 110.8, 52.7.

HRMS (LIFDI, THF): M/z=361.9556 [N4Ge]⁺ (calculated: C₁₈H₁₆N₄Ge: 362.0590).

Elemental analysis: Calculated for N4Ge (%): C, 59.89, H, 4.47, N, 15.52; found: C, 59.43, H, 4.78, N, 15.54.

### 2. Catalysis Reactions

The experiments are catalysis reactions in which strong electron donors are added to the catalyst solely as an additive. This simplifies process control, since isolation of the transition metal compound is not necessary.

As well as the NHGe already shown above (FIG. 2), the ligands known from the literature that are shown in FIG. 3 were also employed as additives for comparison. The investigations below are divided into 4 sections.

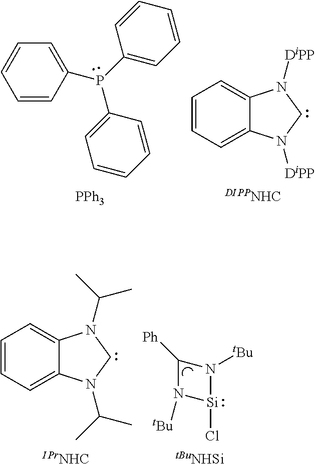

FIG. 3: Alternatively employed additives in platinum-catalyzed olefin hydrosilylation.

### a) Screening of Different Additives

The catalytic reaction is the hydrosilylation of 1-octene (375 mg, 3.34 mmol, 1.65 equivalents) with heptamethyltrisiloxane (450 mg, 2.03 mmol, 1.0 equivalent) in 4 mL of p-xylene (0.5 M HSi). All of the following experiments were carried out in heated glass apparatus under inert gas. The results of the reactions were monitored via gas chromatography using n-decane (405 mg) as internal standard, and the selectivity of the reaction was determined.

To prepare the catalyst solutions, 6.41 mg of Pt₂(dvtms)₃ (0.096 mmol) was dissolved in 19.0 mL of p-xylene and optionally mixed with 0.096 mmol of additive (solution in 1 mL of p-xylene) (1.98 mg ^{iP}NHC, 4.26 mg ^{DIPP}NHC; 2.54 mg PPh₃; 3.08 mg NeoGe; 3.28 mg N3Ge). If no additive was added, the solution was instead diluted with 1.0 mL of p-xylene. These catalyst solutions were stirred for 3 hours at the relevant temperature for the experiment and, in accordance with the experimental details, 0.15 mL (50 ppm [Pt]) or 0.2 mL (66 ppm [Pt]) or 0.4 mL (133 ppm [Pt]) added to the thermally equilibrated substrate mixture.

The use of ^{iP}NHC, ^{DIPP}NHC, and PPh₃ results in initiation phases of varying length; the maximum TOFs (TOF=turnover frequency) vary less strongly. A point to note is the very long initiation phase when using the sterically very demanding ^{DIPP}NHC (complete conversion after approx. 15 hours). The reactions using NeoGe and N3Ge proceed with significantly greater rapidity. Complete conversion is achieved after no later than 100 minutes. All reactions with additive show a higher yield than with Karstedt's catalyst alone.

The results of the reactions with 50 ppm [Pt] are shown in Table 1.

TABLE 1
Conversion and yield of reactions using different
additives. 50 ppm of [Pt] was used in all cases.

| | | Conversion | Yield |
|---|---|---|---|
| Experiment | Catalytic system | [%] | [%] |
| 1 | Karstedt catalyst | 100 | 83 |
| 2 | +1 equiv. iPr-NHC | 100 | 84 |
| 3 | +1 equiv. DiPP-NHC | 100 | 89 |
| 4 | +1 equiv. PPh₃ | 100 | 87 |
| 5 | +1 equiv. NeoGe | 100 | 93 |
| 6 | +1 equiv. N3Ge | 100 | 95 |

The conversion and the product yield were calculated by means of gas chromatography with n-decane as internal standard. In all reactions, complete conversion of the H-silane used was observed. The product yields achieved are shown in Table 1. The product yields achieved for the ligands known from the literature (cf. FIG. 3, experiments 2-4) are in the region of the values presented in the literature for the corresponding isolated (ligand)Pt(dvtms) complexes.

It is noticeable that the reactions with NeoGe and N3Ge achieve significantly higher yields despite the more rapid reaction (experiments 5/6: 93%/95%).

### b) Stoichiometric Addition of Additive Versus Excess Additive

To prepare the catalyst solutions, 6.41 mg of Pt₂(dvtms)₃ (0.096 mmol) was dissolved in 19.0 mL of p-xylene and optionally mixed with 0.192 mmol of additive (solution in 1 mL of p-xylene) (3.96 mg ^{iP}NHC, 8.52 mg ^{DIPP}NHC, 3.19 mg ^{tBu}NHSi, 6.16 mg NeoGe; 6.56 mg N3Ge; 6.98 mg N4Ge). If no additive was added, the solution was instead diluted with 1.0 mL of p-xylene. These catalyst solutions were stirred for 3 hours at the relevant temperature for the experiment and, in accordance with the experimental details, 0.15 mL (50 ppm [Pt]) or 0.2 mL (66 ppm [Pt]) or 0.4 mL (133 ppm [Pt]) added to the thermally equilibrated substrate mixture.

If there is an excess of NHGe, the initiation phase is significantly prolonged. After 180 minutes, a conversion of approx. 15% is observed, with complete conversion of the starting material (H-silane) subsequently achieved (complete conversion after no later than 15 hours, not shown). This is accompanied by an improvement in the selectivity of the reaction by approx. 3 percentage points (Table 2, experiments 2/5: 96%/98%). Increasing the temperature by 30° C. in turn significantly shortens the initiation phase despite the excess of NHGe. The selectivity decreases accordingly (Table 2, experiments 3/6: 89%/93%).

TABLE 2
Conversions and yields of the
reactions using different additives.

| | | | Yield | Yield |
|---|---|---|---|---|
| | Catalytic system, | Conversion | [%] | [%] |
| Experiment | 50 ppm [Pt] | [%] | 70° C. | 100° C. |
| 1 | 1 equiv. NeoGe | 100 | 93 | |
| 2 | 2 equiv. NeoGe | 100 | 96 | |
| 3 | 2 equiv. NeoGe^{[a]} | 100 | | 89 |
| 4 | 1 equiv. N3Ge | 100 | 95 | |
| 5 | 2 equiv. N3Ge | 100 | 98 | |
| 6 | 2 equiv. N3Ge^{[a]} | 100 | | 95 |

(^{[a]}= 133 ppm [Pt])

c) Catalytic Reactions with Excess Additive at 100° C.

To investigate the effect of an additional pyridine donor as a side branch on the germylene, further catalytic experiments were carried out at 100° C. and with an excess of NHGe and compared with conventional ligands. To improve the comparability of the reaction profiles, runs with a higher loading (133 ppm [Pt], 0.4 mL of catalyst solution, 100° C.) were carried out.

The results of the reactions are shown in Table 3.

In the reaction profile, it can be seen that the potentially additional donor in N3Ge results in a prolongation of the initiation phase of the catalysis compared to the pyridine-free NeoGe. The additional donor in N4Ge reinforces this effect further. The yields achieved in each case are shown in Table 3. The reaction with ^{DIPP}NHC (experiment 2) is slower.

TABLE 3
Conversion and yield of the catalysis using various
additives (2 equivalents) at 100° C. and 133 ppm [Pt].

| | | Conversion | Yield |
|---|---|---|---|
| Experiment | Catalytic system | [%] | [%] |
| 1 | Karstedt catalyst (KC) | 100 | 83 |
| 2 | KC + 2 equiv. ^{DIPP}NHC | 100 | 90 |
| 3 | KC + 2 equiv. ^{tBu}NHSi | 100 | 93 |
| 4 | KC + 2 equiv. NeoGe | 100 | 89 |
| 5 | KC + 2 equiv. N3Ge | 100 | 95 |
| 6 | KC + 2 equiv. N4Ge | 100 | 97 |

As can be seen from Table 3, the addition of a strong electron donor as a catalyst additive considerably increases the yield compared to Karstedt's catalyst alone.

Whereas catalysis with Karstedt's catalyst shows a selectivity of only 83% in the absence of further additives, the use of ^{DIPP}NHC (sterically large side branches, very slow reaction) increases this selectivity to 90% (experiments 1 and 2). When using the known ligand ^{tBu}NHSi, a maximum selectivity of 93% is achieved (experiment 3; the ligand ^{tBu}NHSi is a donor-stabilized silylene with strong electron donor properties). The use of chelating germylene additives under the same conditions allows a selectivity of up to 97% to be achieved (experiment 6, 2 equivalents of N4Ge). The progress of the reaction when using the non-chelating and more weakly donating NeoGe is considerably more rapid than the reaction with ^{tBu}NHSi, the yield is accordingly 89%. The use of the additive N3Ge allows a selectivity of 95% to be achieved, the reaction proceeding with greater rapidity than with N4Ge. This is due to the lower chelating capacity of the N3Ge ligand.

d) Catalytic Experiments with 2 Equivalents of N3Ge and 2 Equivalents of N4Ge as Additive at 70° C., 100° C., and 130° C.

The catalyst solutions with excess additive were prepared as described in section b), with 0.2 mL (66 ppm [Pt]; Table 4) used each time.

The catalytic reactions were carried out at a loading of 66 ppm [Pt]. In the reaction profile it can be seen that the initiation phase can be considerably shortened by increasing the temperature. Complete conversion is achieved after no later than 3 hours. The use of NHGe additives is characterized by the ability to at the same time achieve very high selectivity (Table 4).

TABLE 4
Yield of catalysis using 2 equivalents of N3Ge
and N4Ge at 70° C., 100° C., and 130° C.

| | | Yield | Yield | Yield |
|---|---|---|---|---|
| | Catalytic system, | [%] | [%] | [%] |
| Experiment | 66 ppm [Pt] | 70° C. | 100° C. | 130° C. |
| 1 | Karstedt catalyst (KC) | 82 | 79 | 78 |
| 2 | KC + 2 equiv. N3Ge | 95 | 93 | 93 |
| 3 | KC + 2 equiv. N4Ge | 98 | 97 | 94 |

Despite the high temperatures and thus very rapid reactions, high to very high selectivities can still be achieved.

In summary, when using stoichiometric amounts of NHGe additive to the platinum(0) species, complete conversion is achieved much more rapidly than with the other additives. Significantly higher selectivities are also achieved here. The use of additive in a molar excess can result in a significant prolongation of the initiation phase, while the selectivity is improved further. Increasing the temperature has a significant influence on the initiation phase, with high selectivities still achievable by using chelating NHGes. The influence of the pyridine side branch can be clearly seen in section c). Whereas a significant slowing of the reaction occurs, the additional donor improves the selectivity of the catalysis.

The experiments show that a higher temperature accelerates the reaction, but at the same time worsens the selectivity.

The addition of the N-heterocyclic germylenes as a catalyst additive slows the reaction, but also increases the selectivity. The addition of more additive intensifies this effect further.

The reaction conditions, in this case temperature and addition of catalyst additive, more particularly N-heterocyclic germylenes, can be freely combined in order to optimize reaction conditions for the hydrosilylation.

1-15. (canceled)

16. An N-heterocyclic germylene of general formula (I), 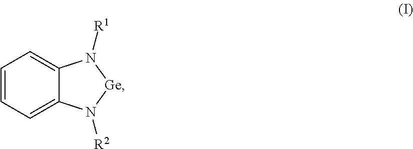
wherein the following applies for the radicals R¹ and R²:
(a) the radicals R¹ and R² are independently selected from substituted or unsubstituted alkyl-attached alkylheteroaryl radicals having a total of 1-30 carbon atoms and at least one heteroatom selected from nitrogen, sulfur, and oxygen;
where substituted means that at least one hydrogen atom of the alkylaryl or alkylheteroaryl radical has been replaced by a C₁-C₁₀ hydrocarbon radical.
or
(b) the radical R¹ is an unsubstituted or substituted pyridin-2-ylmethyl radical, where substituted means that at least one hydrogen atom of the pyridine ring has been replaced by a C₁-C₁₀ hydrocarbon radical, and the radical R² is a neopentyl radical.

17. The N-heterocyclic germylene as claimed in claim 16, wherein the following applies for the radicals R¹ and R²:
(a) the radicals R¹ and R² are independently selected from substituted or unsubstituted alkyl-attached alkylheteroaryl radicals having a total of 1-30 carbon atoms and at least one nitrogen atom;
where substituted means that at least one hydrogen atom of the alkylheteroaryl radical has been replaced by a C₁-C₁₀ hydrocarbon radical.

18. The N-heterocyclic germylene as claimed in claim 17, wherein the following applies for the radicals R¹ and R²:
a) the radicals R¹ and R² are identical and an unsubstituted or substituted pyridin-2-ylmethyl radical, where substituted means that at least one hydrogen atom of the pyridine ring has been replaced by a C₁-C₁₀ hydrocarbon radical.

19. The N-heterocyclic germylene as claimed in claim 16, wherein these are selected from the compounds below

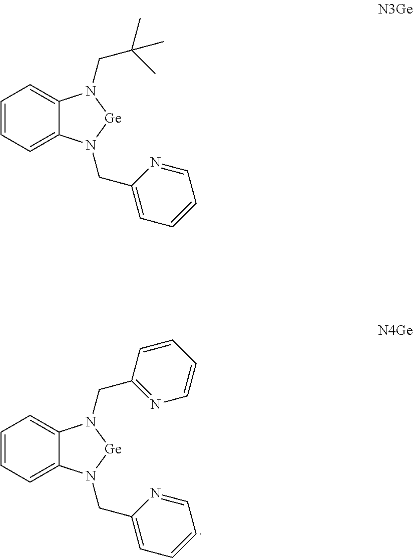

20. A hydrosilylable mixture M comprising
a) at least one compound A having at least one hydrogen atom attached directly to a silicon atom,
b) at least one compound B that contains at least one carbon-carbon multiple bond,
c) at least one hydrosilylation catalyst, and
d) at least one strong electron donor as a catalyst additive.

21. The hydrosilylable mixture M as claimed in claim 20, wherein the strong electron donor is selected from the group consisting of phosphines, carbenes, silylenes, and germylenes.

22. The hydrosilylable mixture M as claimed in claim 20, wherein the strong electron donor is selected from N-heterocyclic germylenes of general formula (I′) 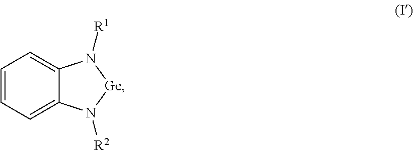
where the radicals R¹ and R² are independently a substituted or unsubstituted hydrocarbon radical having 1-30 carbon atoms, where substituted means that at least one carbon atom has been replaced by a heteroatom selected from nitrogen, sulfur, and oxygen.

23. The hydrosilylable mixture M as claimed in claim 22, wherein the strong electron donor is selected from N-heterocyclic germylenes of claims 1-4.

24. The hydrosilylable mixture M as claimed in claim 20, wherein the hydrosilylation catalyst is a Pt(0) species.

25. The hydrosilylable mixture M as claimed in claim 22, wherein the hydrosilylation catalyst is a Pt(0) species and the molar ratio of hydrosilylation catalyst to N-heterocyclic germylene is within a range from 1:0.1 to 1:10.

26. The hydrosilylable mixture M as claimed in claim 25, wherein the molar ratio of hydrosilylation catalyst to N-heterocyclic germylene is within a range from 1:1 to 1:5.

27. A method for preparing siloxanes, comprising the following steps:
a) preparing a hydrosilylable mixture M as claimed in claim 20 by contacting the individual components with one another,
b) reacting the hydrosilylable mixture M at a temperature within a range from 25° C. to 200° C.

28. The method as claimed in claim 27, wherein the reaction is carried out at a temperature within the range 80-150° C.

29. The use of phosphines, carbenes, silylenes, and germylenes as catalyst additives in noble metal-catalyzed hydrosilylation, especially in platinum(0)-catalyzed hydrosilylation.

30. The use as claimed in claim 29, wherein the germylene is an N-heterocyclic germylene of general formula (I′) 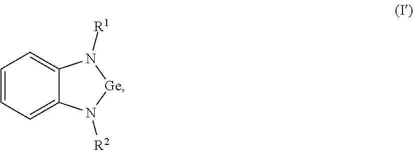
where the radicals R¹ and R² are independently a substituted or unsubstituted hydrocarbon radical having 1-30 carbon atoms, where substituted means that at least one carbon atom has been replaced by a heteroatom selected from nitrogen, sulfur, and oxygen.
